(19) United States
(12) Patent Application Publication
(10) Pub. No.: US 2008/0139292 A1
(43) Pub. Date: Jun. 12, 2008

(54) Gaming machine

(75) Inventor: Hirobumi Toyoda, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp.

(21) Appl. No.: 11/902,120

(22) Filed: Sep. 19, 2007

(30) Foreign Application Priority Data
Sep. 22, 2006 (JP) 2006-258097

(51) Int. Cl. A63F 13/00

(52) U.S. Cl. 463/20

(57) ABSTRACT

A gaming machine includes: a CPU 106 for determining whether or not the game state is to be switched to a special game state advantageous to the player; mechanical reels 30A through 30C each of which is adapted to display multiple kinds of indicating information variably and statically; a motor driving circuit 120 for controlling the display operation of the mechanical reels 30A through 30C; a water tank 500 formed of a translucent material to retain liquid, and provided behind a display screen 10 that is able to display the indicating information on the mechanical reels 30A through 30C; a wave generating device 600 for changing the state of the liquid stored in the water tank 500; and a drive control circuit 300 for controlling the wave generating device 600 according to the result of the determination made by the CPU 106.

This application is based on and claims the benefit of priority from Japanese Patent Application No. 2006-258097, filed on 22 Sep. 2006, the content of which is incorporated herein by reference.

### BACKGROUND OF THE INVENTION

1. Field of the Invention

The present invention relates to a gaming machine such as a slot machine, a pachinko-style slot machine, and a pachinko machine.

2. Related Art

With conventional gaming machines (slot machines), upon the player manipulating an operating means (start lever) after the insertion of a predetermined number of units of a gaming medium (coins or the like), a display means (reels or a liquid crystal display device), which displays multiple indicating information on the outer face thereof in the form of multiple lines (e.g., in the form of a 3×3 matrix), enters a scrolling display mode.

Furthermore, such gaming machines provide the following game. That is to say, upon the player operating the start lever, reels or the like are rotated a predetermined number of times (for a predetermined period of time), following which the rotation thereof is stopped. Then, such a gaming machine pays out an amount of coins based upon the combination of the indicating information rearranged along an active pay line provided to the display means that allows the player to recognize the indicating information.

In addition, in recent years, various ideas have been proposed for improving visual effects. For example, an idea has been proposed for the aforementioned gaming machines, in which a hollow container filled with a liquid is provided forward of a lower panel of a cabinet of the slot machine. With such an arrangement, movable members such as simulated aquatic plants, simulated fishes, etc., are provided within the hollow container. Furthermore, a bubble generator is provided to the hollow container, which provides bubbles in the liquid thus stored (see Patent Document 1).

With the gaming machine disclosed in Patent Document 1, the bubble generator provides bubbles in the liquid according to the progress and situations of the game, thereby providing improved visual effects.

However, with the gaming machine disclosed in Patent Document 1, such components are mounted at a different location from that of the display means that allows the player to recognize the indicating information of variable display, leading to a problem that such components do not attract much attention from the player. In order to solve this problem, a gaming machine is proposed in which a water tank is provided forward of the display means that allows the player to recognize the indicating information of variable display displayed thereon. Such an arrangement provides improved visual effects, examples of which include bubbles provided within the water tank, visual effects provided by a transparent liquid crystal display device provided between the water tank and the display means, etc. (see Patent Documents 2 and 3).

With the gaming machines disclosed in Patent Documents 2 and 3, the water tank is provided forward of the display means that allows the player to recognize the indicating information of variable display displayed thereon. Such an arrangement allows the player to recognize the indicating information of variable display displayed on the display means while viewing the visual effects provided by the water tank. Thus, such visual effects attract the player's attention.

### [Patent Document 1]

Japanese Unexamined Patent Application, First Publication No. 2001-46583

### [Patent Document 2]

Japanese Unexamined Patent Application, First Publication No. 2005-230190

### [Patent Document 3]

Japanese Unexamined Patent Application, First Publication No. 2006-141634

However, there is a problem with the gaming machines disclosed in Patent Documents 2 and 3, which have a configuration in which the water tank is provided forward of the display means. That is to say, with such an arrangement, the information provided by the display means is thus displayed to the player through the medium of the water tank. In some cases, if something interrupts the player's view, or if there is a large distance between the display means and the player, the player cannot recognize the information displayed by the display means. Such a problem limits the permissible size and shape of the water tank, leading to such a water tank providing only limited visual effects.

The present invention has been made in view of the aforementioned problems. It is an object of the present invention to provide a gaming machine which provides improved visual effects by using a water tank, while facilitating the player's ability to visually recognize the information displayed by the display means.

### SUMMARY OF THE INVENTION

In order to achieve the aforementioned purpose, the present invention provides the following arrangements.

In a first aspect of the present invention, a gaming machine includes: an operating means for allowing a player to operate the gaming machine; a game control means for providing a function whereby, upon the player performing an operation by way of the operating means, determination is made whether or not a game state is to be switched to a special game state advantageous to the player; a display means, which is formed of a translucent material, and for displaying multiple kinds of indicating information variably and statically; a display control means for controlling a display operation of the display means, which provides a function of displaying the indicating information variably and statically, according to a determination made by the game control means; a water tank which is formed of a translucent material, retains liquid, and is provided behind a display screen of the display means for displaying the indicating information; a liquid state changing means for changing the state of the liquid stored in the water tank; and a drive control means for controlling the liquid state changing means according to the result of the determination made by the game control means.

According to the first aspect of the invention, upon the player manipulating the operating means, the game control means determines whether or not the game state is to be switched to the special game state advantageous to the player. The display means, which is formed of a translucent material, displays multiple kinds of indicating information variably and statically. The display control means controls the display operation of the display means which has a function of displaying indicating information variably and statically according to the result of the determination made by the game control means. A water tank, which retains liquid and which is formed of a translucent material, is provided behind the display screen that displays the indicating information provided by the display means.

With such an arrangement, the drive control means controls the liquid state changing means, which changes the state of the liquid stored in the water tank according to the result of the determination made by the game control means.

With such an arrangement, the water tank, which retains liquid, is provided behind the display means, which provides a function of displaying the multiple kinds of indicating information variably and statically. Such an arrangement allows the player to simultaneously recognize both the multiple kinds of indicating information displayed by the display means via the display screen and the water tank provided behind the display screen. In addition, the water tank can be designed without having to take into account whether or not the water tank interrupts the player's view of the display screen that displays the indicating information provided by the display means (e.g., reels or liquid crystal display device). Thus, with such an arrangement, the water tank can be formed with an increased depth as compared with an arrangement in which the water tank is provided forward of the display means. Various kinds of items which provide visual effects (e.g., simulated pirate ships, simulated tropical fish, and simulated aquatic plants, all of which can be moved by magnetic force) can be arranged in such a water tank thus designed.

Furthermore, the display means provides a function of displaying the indicating information variably and statically according to the result of the determination made by the game control means of whether or not the game state is to be switched to the special game state advantageous to the player. In addition, the liquid state changing means provides a function of changing the state of the liquid stored in the water tank according to the determination result. Thus, with such an arrangement, visual effects are displayed in a superimposed manner, and are provided by the combination of the indicating information display operation, which displays the indicating information variably and statically, and the liquid state changing operation, which changes the state of the liquid stored in the water tank. The player is thereby provided with notice that the game state will transit to a special game state advantageous to the player, which is of great interest to the player. This improves the visual effects provided using the water tank.

Thus, such an arrangement provides improved visual effects by using the water tank, while facilitating the player's ability to visually recognize the information displayed by the display means.

In a second aspect of the gaming machine as described in the first aspect of the present invention, the liquid state changing means may be a wave generating means which is disposed in the liquid stored in the water tank, and which has a movable plate member. In addition, the drive control means may control the movement of the plate member of the wave generating means.

According to the second aspect of the invention, the drive control means performs a control operation which instructs the wave generating means to move the movable plate member arranged in the liquid stored in the water tank.

Such an arrangement provides a function of moving the plate member in the liquid stored in the water tank, which generates convection currents in the liquid stored in the water tank, and which generates waves on the surface of the liquid. Thus, such an arrangement generates waves on the surface of the liquid stored in the water tank according to the result of the determination of whether or not the game state is to be switched to the special game state advantageous to the player.

For example, with such an arrangement, the game control means determines by random number lottery processing whether or not the game state is to be switched to a special game state advantageous to the player, whereupon the drive control means performs a control operation for moving the plate member of the wave generating means with reference to the wave generation table according to the result of the determination of whether or not the game state is to be switched to the special game state advantageous to the player. Here, a storage means is provided, and the storage means stores a wave generation table that specifies a relation between the probability that the game state will transit to the advantageous game state, which is used in the random number lottery processing, and the distance by which the plate member is to be moved. In the wave generation table, the distance by which the plate member is to be moved is proportional to the probability that the game state will transit to the advantageous game state. With such an arrangement, the waves thus generated on the surface of the liquid become larger as the probability that the game state will transit to the advantageous game state becomes higher. With such an arrangement, the waves thus generated on the surface of the liquid further enhance the player's sense of expectation with respect to game state transition to the special game state advantageous to the player.

Thus, such an arrangement provides improved visual effects by using the water tank, while facilitating the player's ability to visually recognize the information displayed by the display means.

In a third aspect of the gaming machine as described in the first aspect of the present invention, the liquid state changing means may be a water amount changing means which provides a function of injecting liquid into the water tank, and a function of draining liquid from the water tank. In addition, the drive control means may control via the water amount changing means the amount of the liquid to be injected into the water tank, and the amount of the liquid to be drained from the water tank.

According to the third aspect of the invention, the drive control means instructs the water amount changing means to control the amount of liquid to be injected into the water tank and the amount of liquid to be drained from the water tank.

Such an arrangement provides a function of changing the amount of liquid to be injected into the water tank and the amount of liquid to be drained from the water tank. This allows the level of the liquid stored in the water tank to be changed. Such an arrangement provides a function of changing the level of the liquid stored in the water tank according to the result of the determination of whether or not the game state is to be switched to the special game state advantageous to the player.

For example, with such an arrangement, the game control means determines by random number lottery processing whether or not the game state is to be switched to a special game state advantageous to the player, upon which the drive control means instructs the water amount changing means to control the amount of liquid to be injected into the water tank and the amount of liquid to be drained from the water tank with reference to the water amount table according to the result of the determination of whether or not the game state is to be switched to the special game state advantageous to the player. Here, a storage means is provided, and the storage means stores a water amount table that specifies the relation between the probability that the game state will transit to the advantageous game state, which is used in the random number lottery processing, and the amount of liquid to be stored in the water tank. In the water amount table, the amount of liquid to be stored in the water tank is proportional to the probability that the game state will transit to the advantageous game state. With such an arrangement, the level of the liquid stored in the water tank becomes higher as the probability that the game state will transit to the advantageous game state becomes higher. With such an arrangement, the rise in the level of the liquid stored in the water tank further enhances the player's sense of expectation with respect to the game state transition to the special game state advantageous to the player.

Thus, such an arrangement provides further improved visual effects by using the water tank, while facilitating the player's ability to visually recognize the information displayed by the display means.

According to the present invention, a water tank that retains liquid is provided behind a display screen for displaying indicating information provided by a display means, which has a function of displaying multiple kinds of indicating information variably, and which is formed of a translucent material. With such an arrangement, a drive control means controls a liquid state changing means which has a function of changing the state of the liquid stored in the water tank according to the result of a determination made by a game control means. Thus, such an arrangement provides further improved visual effects by using the water tank, while facilitating the player's ability to visually recognize the information displayed by the display means.

### BRIEF DESCRIPTION OF THE DRAWINGS

FIG. 1 is a perspective view showing the exterior of a slot machine according to a first embodiment of the present invention;

FIG. 2 is a cross-sectional view showing a reel group and a water tank included in the slot machine according to the first embodiment of the present invention;

FIG. 3 is a front view showing a display screen for displaying mechanical reels, a water tank, and a wave generating means, according to the first embodiment of the present invention;

FIG. 4 is a front view showing the display screen for displaying the mechanical reels, the water tank, and the wave generating means, according to the first embodiment of the present invention;

FIG. 5 is a block diagram showing an electrical configuration of a control device according to the first embodiment of the present invention;

FIG. 6 is a flowchart for a game control means included in the slot machine according to the embodiment of the present invention;

FIG. 7 is a diagram showing a wave generating table according to the first embodiment of the present invention;

FIG. 8 is a front view showing a display screen for displaying mechanical reels, a water tank, and a water amount changing means, according to a second embodiment of the present invention;

FIG. 9 is a front view showing the display screen for displaying the mechanical reels, the water tank, and the water amount changing means, according to the second embodiment of the present invention;

FIG. 10 is a block diagram showing an electrical configuration of a control device according to the second embodiment of the present invention;

FIG. 11 is a diagram showing a water amount table according to the second embodiment of the present invention;

FIG. 12 is a perspective view showing the exterior of a slot machine according to a third embodiment of the present invention;

FIG. 13 is a cross-sectional view showing a liquid crystal display device and a water tank included in the slot machine according to the third embodiment of the present invention; and

FIG. 14 is a block diagram showing an electrical configuration of a control device according to the third embodiment of the present invention.

### DETAILED DESCRIPTION OF THE INVENTION

A detailed description is provided below regarding embodiments of the present invention.

### First Embodiment

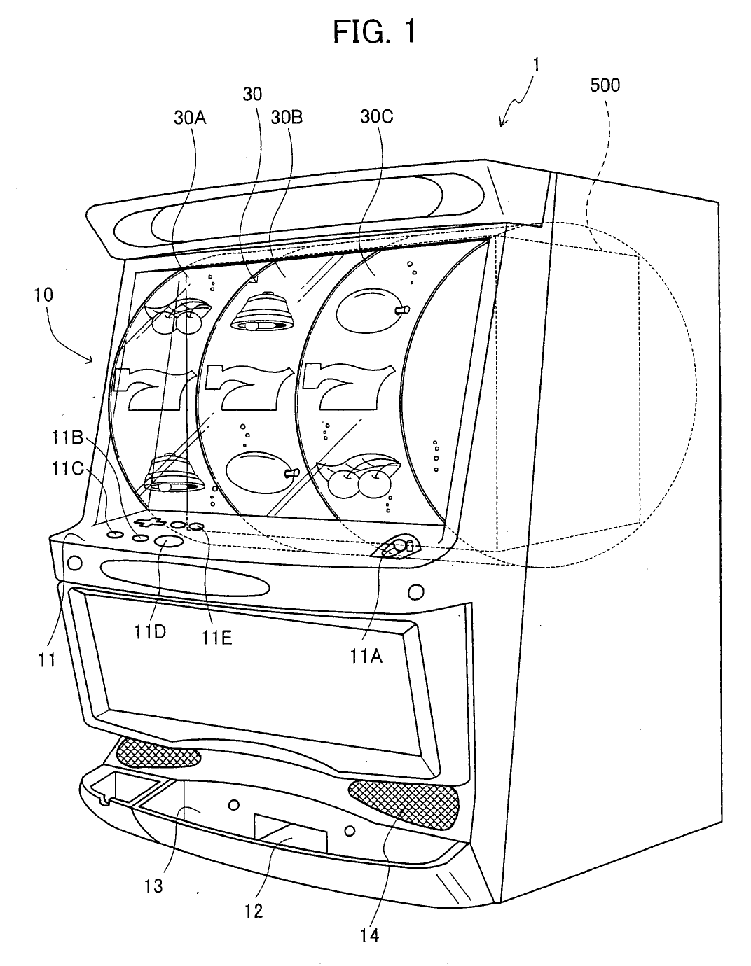

FIG. 1 is a perspective view showing the exterior of a slot machine 1 according to a first embodiment of the present invention. The slot machine 1 according to the embodiment of the present invention includes a reel group 30, an operation panel 11, a coin payout opening 12, a coin tray 13, and a sound output unit 14. It should be noted that slot machines can be roughly classified into two types. One is a slot machine having a configuration in which mechanical reels are rotated. The other is a so-called video slot machine having a configuration in which multiple virtual reels are rotated in the form of an image displayed on a screen. While a description is provided in the present embodiment regarding a slot machine employing mechanical reels, the present invention may also be applied to a video slot machine.

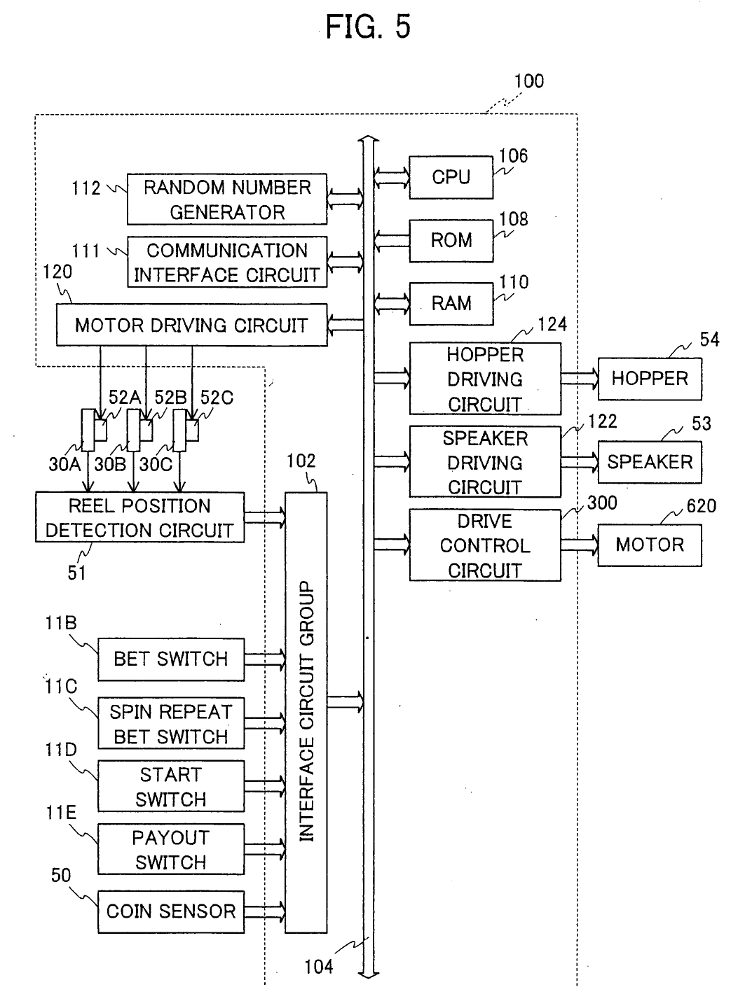

The slot machine 1 is installed at a predetermined location in an amusement facility such as a casino, etc. Furthermore, the slot machine 1 includes a control device 100 (see FIG. 5) or the like mounted therewithin for electrically controlling each component thereof. A description is provided later regarding the control device 100.

The reel group 30 has a structure in which three cylindrical mechanical reels 30A through 30C are rotatably disposed along a horizontal line. Furthermore, the mechanical reels 30A through 30C are provided such that they can rotate around the circumference of a water tank 500. Multiple kinds of indicating information are provided on the outer face of each of the mechanical reels 30A through 30C. Such an arrangement displays the indicating information variably and statically on a display screen 10 that allows the player to recognize the indicating information. The multiple kinds of indicating information include a “red 7” design, a “blue 7” design, a “BAR” design, a “bell” design, a “watermelon” design, and a “cherry” design. Here, each of the three mechanical reels 30A through 30C is formed of a translucent material.

In other words, the mechanical reels 30A through 30C provide a function of displaying the multiple kinds of indicating information variably and statically. That is to say, the mechanical reels 30A through 30C serve as an example of a display means formed of a translucent material. Furthermore, each of the mechanical reels 30A through 30C is formed in a cylindrical shape, on the outer face of which are depicted multiple kinds of indicating information. Each reel is provided such that it can be rotated around the circumference of the water tank.

The operation panel 11 includes a coin insertion opening 11A which allows the player to insert coins into the slot machine 1. Furthermore, the operation panel 11 includes a BET switch 11B which allows the player to select the number of coins, which serve as the units of the gaming medium used in the game by the player. Moreover, the operation panel 11 includes a spin repeat bet switch 11C which allows the player to play the game again without changing the number of coins to be spent in the game from that in the immediately previous game. The slot machine 1 allows the player to set the number of coins to be spent in the game by performing a pushing operation on either the BET switch 11B or the spin repeat bet switch 11C.

Furthermore, the operation panel 11 includes a start switch 11D, which is a game start instruction receiving means that allows the player to input the game start instruction in increments of games. With the slot machine 1, upon the player performing a pushing operation on either the spin repeat bet switch 11C or the start switch 11D, a start operation signal is transmitted to a CPU 106 (see FIG. 5) described later. This starts the game, upon which a scrolling operation is performed for the reel group 30.

Furthermore, the operation panel 11 includes a payout switch 11E. Upon the player performing a pushing operation on the payout switch 11E, the coins inserted by the player are paid out via the coin payout opening 12. The coins to be paid out are retained in the coin tray 13.

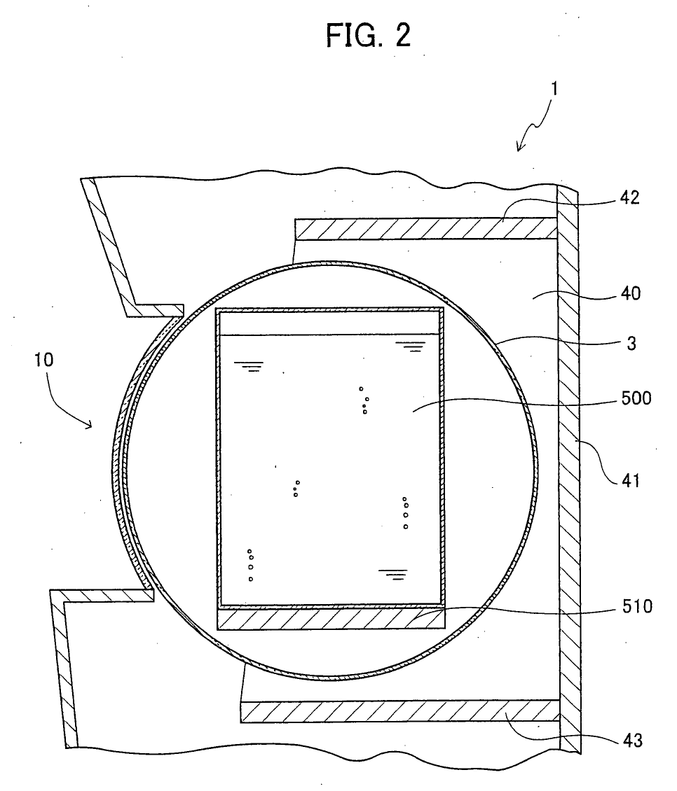

FIG. 2 is a cross-sectional diagram showing the reel group 30 and the water tank 500 included in the slot machine 1 according to the first embodiment of the present invention.

Each of the mechanical reels 30A through 30C is independently rotatably supported by a reel frame 40. It should be noted that an unshown stepping motor is provided to the reel frame 40 for providing a function of rotating each of the mechanical reels 30A through 30C, and a function of stopping the rotation thereof. The reel frame 40 is disposed between an upper frame 42 and a lower frame 43 provided to a main frame 41.

The water tank 500 is disposed in the space within the three cylindrical mechanical reels 30A through 30C, and is supported by the cabinet of the slot machine 1 through a water tank frame 510. Here, the water tank 500 is formed approximately in the shape of a rectangular parallelepiped, and is formed of a translucent material which is capable of retaining liquid. It should be noted that the water tank 500 according to the present embodiment is not restricted to such an arrangement. Rather, the water tank 500 may be formed in any desired shape, e.g., approximately in the shape of a cylinder. Also, various kinds of items for providing visual effects may be arranged within the water tank 500 (examples of which include simulated pirate ships, simulated tropical fish, and simulated aquatic plants, all of which can be moved by magnetic force).

In other words, the water tank 500 is provided behind the display screen that serves as a display means for displaying the indicating information. Here, the water tank 500 is a water tank which is capable of retaining liquid and is formed of a translucent material, for example.

Next, a description is provided regarding a structure of a wave generating means 600, which serves as a liquid state changing means that changes the state of the liquid stored in the water tank 500.

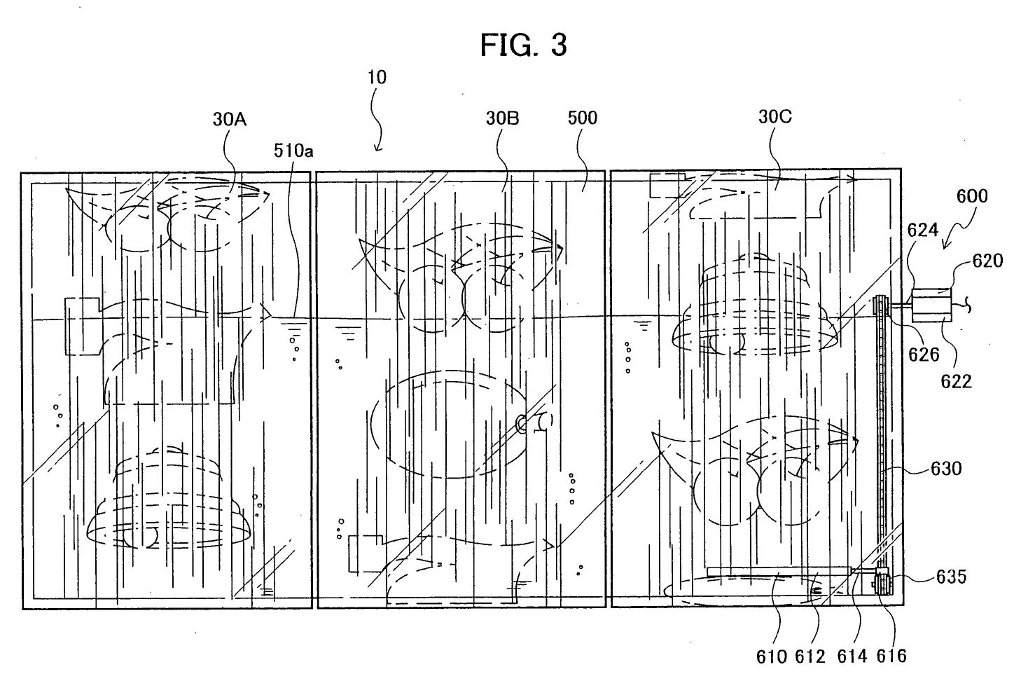

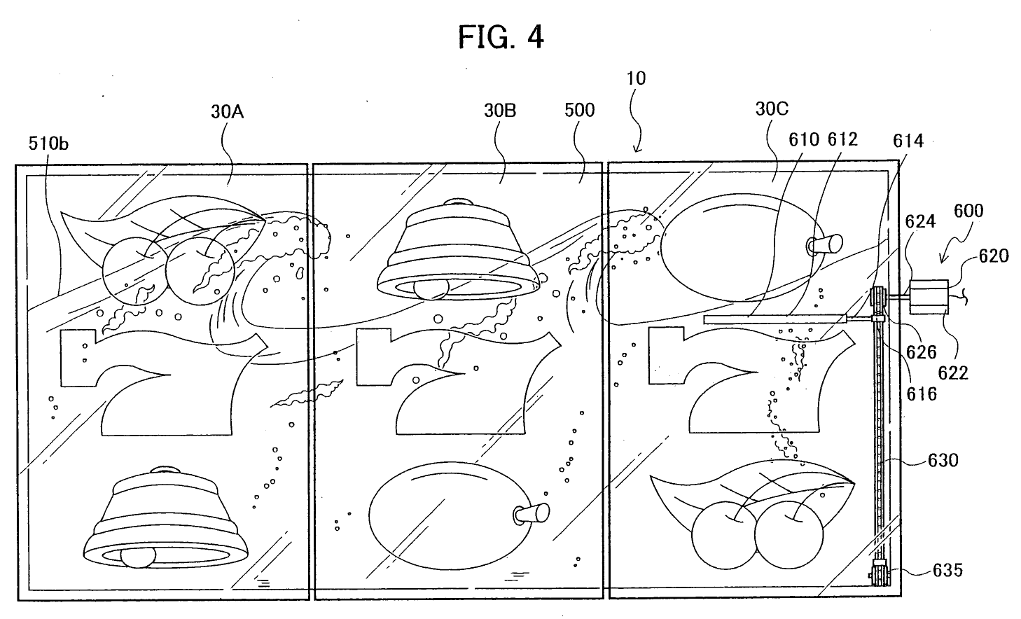

FIG. 3 and FIG. 4 are front views showing the display screen 10 for displaying the mechanical reels 30A through 30C, the water tank 500, and the wave generating means 600 according to the present embodiment.

The wave generating means 600 is disposed in the liquid stored in the water tank 500. The wave generating means 600 includes: a movable plate member 610; a motor 620 which moves the plate member 610; and a chain 630 which transmits the driving force of the motor 620 to the plate member 610.

The plate member 610 includes: a planar part 612 formed such that a surface thereof faces the water depth direction of the water tank 500; a shaft part 614 which extends from the end of the planar part 612; and a gear part 616 formed at the tip of the shaft part 614.

The motor 620 is provided near the upper region of the side face of the water tank 500. The motor 620 includes: a motor main unit 622 which generates rotational driving force; a motor shaft 624 which transmits the rotational driving force generated by the motor main unit 622 to an external mechanism; and a motor gear part 626 provided at the tip of the motor shaft 624. The driving of the motor 620 is controlled by a drive control circuit 300 (see FIG. 5) described later.

The motor shaft 624 is rotatably provided such that it passes through the side wall of the water tank 500. A rubber packing is provided to the portion where the motor shaft 624 passes through the side wall of the water tank 500, which maintains the waterproof condition of the water tank 500.

The chain 630 is formed in the shape of a ring. The chain 630 is wound around a pulley 635 that is rotatably provided at a region on the bottom side of the side wall of the water tank 500, and around the motor gear part 626 of the motor 620 that is provided near the upper region of the side wall of the water tank 500. Furthermore, the gear part 616 of the plate member 610 is engaged with an intermediate portion of the chain 630.

Next, a description is provided regarding the operation of the wave generating means 600.

As shown in FIG. 3, multiple kinds of indicating information provided on the mechanical reels 30A through 30C are displayed via the display screen 10 variably. In this stage, the plate member 610 of the wave generating means 600 is arranged on the bottom side of the water tank 500. Subsequently, if the indicating information provided on the mechanical reels 30A through 30C are displayed via the display screen 10 in a predetermined special stationary state (e.g., the indicating information “red 7”, “red 7”, and “red 7” are rearranged in the stationary state) as shown in FIG. 4, the motor 620 is driven and controlled by the drive control circuit 300 (see FIG. 5) described later, upon which the motor 620 is rotationally driven in the clockwise direction. This rotates the chain 630 in the clockwise direction, which moves upward the plate member 610, which is engaged with the chain 630 through the gear part 616. On the other hand, when the motor 620 is rotationally driven in the counterclockwise direction, the chain 630 is rotated in the counterclockwise direction, thereby moving the plate member 610 downward. With such an arrangement, the plate member 610 is driven vertically in a reciprocating manner, which generates convection currents in the liquid stored in the water tank 500, and which generates waves on the surface of the liquid.

In other words, the wave generating means 600 serves as an example of a liquid state changing means which changes the state of the liquid stored in the water tank. Furthermore, the wave generating means 600 serves as an example of a wave generating means which is disposed in the liquid stored in the water tank, and which includes a movable plate member.

Next, a description is provided regarding a configuration of the control device 100.

FIG. 5 is a block diagram showing an electrical configuration of the control device 100 according to the first embodiment of the present invention.

The control device 100 is a microcomputer, and includes an interface circuit group 102, an input/output bus 104, a CPU 106, ROM 108, RAM 110, a communication interface circuit 111, a random number generator 112, a motor driving circuit 120, a speaker driving circuit 122, and a hopper driving circuit 124.

The interface circuit group 102 is connected to the input/output bus 104. Furthermore, the input/output bus 104 inputs and outputs data signals or address signals to and from the CPU 106.

The start switch 11D is connected to the interface circuit group 102. The start signal output from the start switch 11D is converted into a predetermined signal by the interface circuit group 102, and the start signal thus converted is supplied to the input/output bus 104.

Furthermore, the BET switch 11B, the spin repeat bet switch 11C, and the payout switch 11E are connected to the interface circuit group 102. Each of the switching signals output from these switches 11B, 11C, and 11E is also supplied to the interface circuit group 102, and is converted into a predetermined signal by the interface circuit group 102. The switching signals thus converted are supplied to the input/output bus 104.

Furthermore, a coin sensor 50 is connected to the interface circuit group 102. The coin sensor 50 is a sensor for detecting the coins inserted into the coin insertion opening 11A. The coin sensor 50 is provided in combination with the coin insertion opening 11A. The sensing signal output from the coin sensor 50 is also sent to the interface circuit group 102, and is converted into a predetermined signal by the interface circuit group 102. The sensing signal thus converted is sent to the input/output bus 104.

Furthermore, a reel position detecting circuit 51 is connected to the interface circuit group 102. The reel position detecting circuit 51 is a circuit for detecting the rotational position for each of the mechanical reels 30A through 30C based upon the pulse signals received from a reel rotational position sensor (not shown). The detection signal output from the reel position detecting circuit 51 is also supplied to the interface circuit group 102, and is converted into a predetermined signal by the interface circuit group 102. The detection signal thus converted is sent to the input/output bus 104.

Furthermore, the ROM 108 and the RAM 110 are connected to the input/output bus 104.

According to a program stored in the ROM 108, which is described later in detail, the CPU 106 controls the execution of a game provided by the slot machine 1.

The ROM 108 stores: a control program for central control of the slot machine 1; initialization data for executing the control program; and various data tables used in the lottery processing.

The RAM 110 temporarily stores flags, variables, etc., used for the aforementioned control program.

Furthermore, a communication interface circuit 111 is connected to the input/output bus 104. The communication interface circuit 111 is a circuit for communicating with a server, etc., via various kinds of communication networks including a public telephone line network, LAN, etc.

Moreover, the random number generator 112 for generating a random number is connected to the input/output bus 104. The random number generator 112 generates a random number in a predetermined range, e.g., a range between 0 and 65535. Alternatively, an arrangement may be made in which the CPU 106 generates a random number by computation.

A motor driving circuit 120 for driving the stepping motors 52A through 52C is connected to the input/output bus 104. The CPU 106 controls the operation of the stepping motors 52A through 52C via the motor driving circuit 120 according to the occurrence of predetermined events.

In addition, the speaker driving circuit 122 for driving the speaker 53 is connected to the input/output bus 104. The CPU 106 reads out the sound data stored in the ROM 108, and transmits the sound data thus read out to the speaker driving circuit 122 via the input/output bus 104, thereby providing predetermined sound effects generated by the speaker 53.

Furthermore, the hopper driving circuit 124 for driving the hopper 54 is connected to the input/output bus 104. Upon reception of a cash out signal input from the payout switch 11E, the CPU 106 transmits a driving signal to the hopper driving circuit 124 via the input/output bus 104. The hopper 54 then proceeds to pay out an amount of coins that corresponds to the credits remaining at the current point in time, as stored in a predetermined memory area of the RAM 110.

Moreover, the drive control circuit 300 is connected to the input/output bus 104, which provides a function of driving the motor 620 (see FIG. 3) of the wave generating means 600. If a predetermined event occurs, the CPU 106 controls the operation of the motor 620 via the drive control circuit 300, thereby moving the plate member 610 (see FIG. 3) of the wave generating means 600.

In other words, the drive control circuit 300 serves as an example of a drive control means for controlling operation of moving the plate member of the wave generating means.

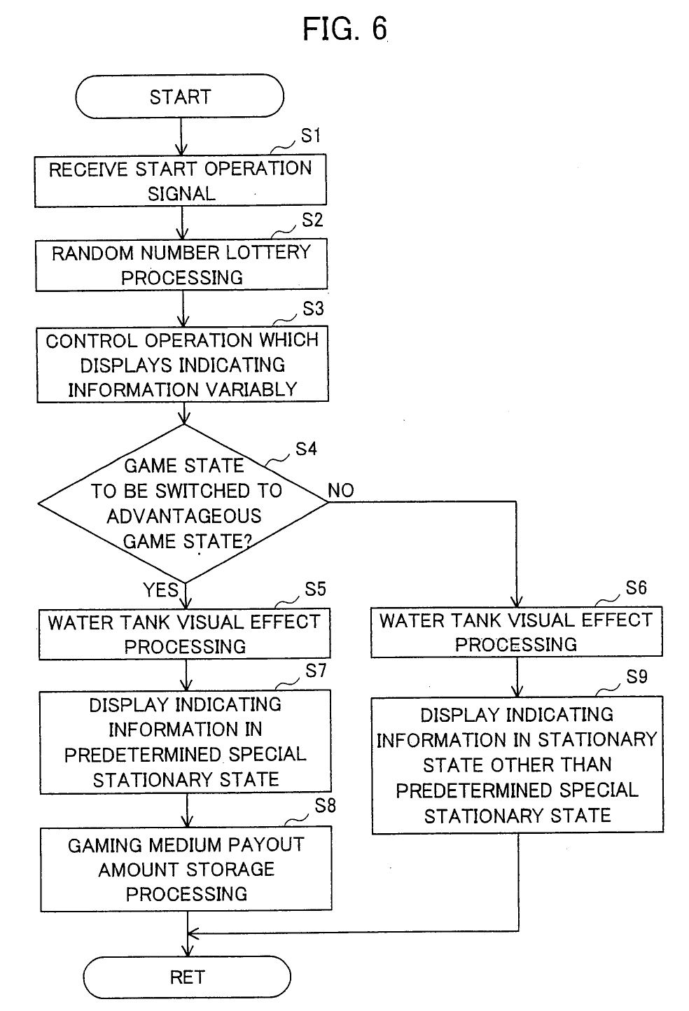

Next, a description is provided regarding the operation of the CPU 106 that controls the execution of a game provided by the slot machine 1 according to the first embodiment with reference to a flowchart shown in FIG. 6.

In step S1, the CPU 106 receives a start operation signal. In this processing, upon the player performing a pushing operation on either the spin repeat bet switch 11C or the start switch 11D, a start operation signal is transmitted, upon which the CPU 106 receives the start operation signal thus transmitted. Upon completion of this processing, the CPU 106 switches the processing to step S2.

In step S2, the CPU 106 performs random number lottery processing. In this processing, the CPU 106 instructs the random number generator 112 to generate a random number, and extracts the random number thus generated. Upon completion of this processing, the CPU 106 switches the processing to step S3.

In step S3, the CPU 106 performs indicating information variable display control processing. In this processing, the CPU 106 transmits a command which instructs the motor driving circuit 120 to rotate the mechanical reels 30A through 30C. Upon reception of this command, the motor driving circuit 120 performs a control operation so as to rotate the mechanical reels 30A through 30C. In other words, the motor driving circuit 120 serves as an example of a display control means which is a rotational driving device for driving the reels. Upon completion of this processing, the CPU 106 switches the processing to step S4.

In step S4, the CPU 106 determines whether or not the game state is to be switched to an advantageous game state. In this processing, the CPU 106 determines whether or not the random number thus extracted in step S2 is within a predetermined range. In a case where the CPU 106 determines that the random number is within the predetermined range, the CPU 106 determines that the game state is to be switched to the advantageous game state, upon which the processing is switched to step S5. On the other hand, in a case where the CPU 106 does not determine that the random number is within the predetermined range, the CPU 106 determines that the game state is not to be switched to the advantageous game state, upon which the processing is switched to step S6.

In other words, the CPU 106 provides: a function as an operating means which allows the player to operate the slot machine 1; and a function as an example of a game control means which determines, for every instance of the player performing an operation via the operating means, whether or not the game state is to be switched to the game state that is advantageous to the player.

The term “game state advantageous to the player” represents the state in which the following conditions are satisfied. First, in the processing in step S5 described later, the condition that the indicating information depicted on the mechanical reels 30A through 30C are displayed on the display screen 10 in a predetermined stationary state (e.g., the indicating information “red 7”, “red 7”, and “red 7” are rearranged in the stationary state). Second, in the processing in step S8 described later, the condition that the gaming medium payout amount is stored in a predetermined memory region of the RAM 110, which is used in payout processing in which a predetermined amount of the gaming medium is paid out.

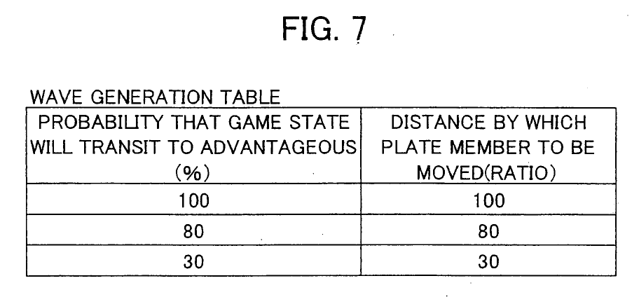

In step S5 and step S6, the CPU 106 performs water tank visual effect control processing. In this processing, the CPU 106 controls the operation of the motor 620 via the drive control circuit 300 according to the determination made in step S4 with reference to a wave generation table (see FIG. 7), thereby moving the plate member 610 (see FIG. 3) of the wave generating means 600. Upon completion of this processing, the CPU 106 switches the processing to step S7 or step S9.

In step S7, the CPU 106 performs a control operation so as to display the indicating information in a predetermined special stationary state. In this processing, the CPU 106 transmits a command which is an instruction to the motor driving circuit 120 to display the indicating information depicted on the mechanical reels 30A through 30C on the display screen 10 in a predetermined special stationary state (e.g., the indicating information “red 7”, “red 7”, and “red 7” are rearranged in the stationary state). Upon reception of this command, the motor driving circuit 120 performs a control operation so as to display the indicating information depicted on the mechanical reels 30A through 30C on the display screen 10 in the predetermined special stationary state (e.g., the indicating information “red 7”, “red 7”, and “red 7” are rearranged in the stationary state). Upon completion of this processing, the CPU 106 switches the processing to step S8.

In step S8, the CPU 106 performs gaming medium payout amount storage processing. In this processing, the CPU 106 stores the gaming medium payout amount, which is used in the processing in which a predetermined amount of the gaming medium is paid out, in a predetermined memory region of the RAM 110, according to the determination made in step S4 that the game state is to be switched to a special game state advantageous to the player. Upon completion of this processing, the CPU 106 ends one game.

In step S9, the CPU 106 performs a control operation so as to display the indicating information in a stationary state other than the aforementioned predetermined special stationary state. In this processing, the CPU 106 transmits a command which is an instruction to the motor driving circuit 120 to display the indicating information depicted on the mechanical reels 30A through 30C on the display screen 10 in a stationary state other than the aforementioned predetermined special stationary state (e.g., other than the state in which the indicating information “red 7”, “red 7”, and “red 7” are rearranged in the stationary state). Upon reception of this command, the motor driving circuit 120 performs a control operation so as to display the indicating information depicted on the mechanical reels 30A through 30C on the display screen 10 in a stationary state other than the aforementioned predetermined special stationary state. Upon completion of this processing, the CPU 106 ends one game.

In other words, the CPU 106 serves as an example of a game control means which controls the execution of a game.

Next, a description is provided regarding the wave generation table used by the CPU 106 as a reference in the processing denoted by the aforementioned step S5 and step S6.

FIG. 7 shows the wave generation table.

The probability that the game state will transit to the advantageous game state and the corresponding distance by which the plate member 610 (see FIG. 3) is to be moved are stored in the wave generation table in the ROM 108. Specifically, if the probability that the game state will transit to the advantageous game state is 100%, the distance by which the plate member 610 is to be moved is set to 100; if the probability is 80%, the distance by which the plate member 610 is to be moved is set to 80; and if the probability is 30%, the distance by which the plate member 610 is to be moved is set to 30.

The first embodiment provides the following advantages.

(1) When the player performs an operation on either the spin repeat bet switch 11C or the start switch 11D, the CPU 106 determines whether or not the game state is to be switched to a special game state advantageous to the player. The mechanical reels 30A through 30C, which are formed of a translucent material, provide a function of displaying multiple kinds of indicating information variably and statically. The motor driving circuit 120 controls the display operation of the mechanical reels 30A through 30C for displaying the indicating information variably and statically according to the result of the determination made by the CPU 106. Furthermore, the water tank 500, which is capable of retaining liquid and is formed of a translucent material, is provided behind the display screen 10 that displays the indicating information provided on the mechanical reels 30A through 30C.

With such an arrangement, the drive control circuit 300 controls the wave generating means 600, which provides a function of changing the state of the liquid stored in the water tank 500 according to the result of the determination made by the CPU 106.

With such an arrangement, the water tank 500, which retains liquid, is provided behind the mechanical reels 30A through 30C, which provide a function of displaying multiple kinds of indicating information variably and statically. Such an arrangement allows the player to recognize both the multiple kinds of indicating information provided by the mechanical reels 30A through 30C, displayed via the display screen 10, and the water tank 500, provided behind the display screen 10. Furthermore, with such an arrangement, the water tank 500 can be designed without having to take into account whether or not the water tank 500 interrupts the player's view of the display screen 10 that displays the indicating information depicted on the mechanical reels 30A through 30C. Thus, with such an arrangement, the water tank 500 can be formed with an increased depth as compared with an arrangement in which the water tank 500 is provided forward of the mechanical reels 30A through 30C. Various kinds of items which provide visual effects (e.g., simulated pirate ships, simulated tropical fish, and simulated aquatic plants, all of which can be moved by magnetic force) can be arranged in such a water tank 500 thus designed.

Furthermore, the CPU 106 instructs the mechanical reels 30A through 30C to display the indicating information variably and statically according to the result of the determination of whether or not the game state is to be switched to a special game state advantageous to the player. In addition, the CPU 106 instructs the wave generating means 600 to change the state of the liquid stored in the water tank 500 according to the aforementioned determination result. Thus, with such an arrangement, visual effects are displayed in a superimposed manner, and are provided by the combination of the indicating information display operation, which displays indicating information variably and statically, and the liquid state changing operation, which changes the state of the liquid stored in the water tank 500. The player is thereby provided with notice that the game state will transit to a special game state advantageous to the player, which is of great interest to the player. This improves the visual effects provided using the water tank 500.

Thus, such an arrangement provides improved visual effects by using the water tank 500, while facilitating the player's ability to visually recognize the information displayed on the mechanical reels 30A through 30C.

(2) The drive control circuit 300 performs a control operation for moving the movable plate member 610, which is a component of the wave generating means 600 and is disposed in the liquid stored in the water tank 500.

Such an arrangement provides a function of moving the plate member 610 in the liquid stored in the water tank 500. This generates convection currents in the liquid, which generates waves on the surface of the liquid. Such an arrangement provides a function of generating waves on the surface of the liquid stored in the water tank 500 according to the result of the determination of whether or not the game state is to be switched to a special game state advantageous to the player.

With such an arrangement, the CPU 106 determines by random number lottery whether or not the game state is to be switched to a special game state advantageous to the player, upon which the drive control circuit 300 performs a control operation for moving the plate member 610 of the wave generating means 600, with reference to the wave generation table, according to the result of the determination of whether or not the game state is to be switched to the special game state advantageous to the player. Here, the ROM 108 stores a wave generation table that specifies the relation between the probability that the game state will transit to the advantageous game state, which is used in the random number lottery processing, and the distance by which the plate member 610 is to be moved. In the wave generation table, the distance by which the plate member 610 is to be moved is proportional to the probability that the game state will transit to the advantageous game state. With such an arrangement, the waves thus generated on the surface of the liquid become larger as the probability that the game state will transit to the advantageous game state becomes higher. With such an arrangement, the waves thus generated on the surface of the liquid further enhance the player's sense of expectation with respect to game state transition to the special game state advantageous to the player.

Thus, such an arrangement provides improved visual effects by using the water tank 500, while facilitating the player's ability to visually recognize the information displayed on the mechanical reels 30A through 30C.

### Second Embodiment

In the following description of a second embodiment, the same components as those in the first embodiment are denoted by the same reference numerals, and a description thereof is omitted or simplified.

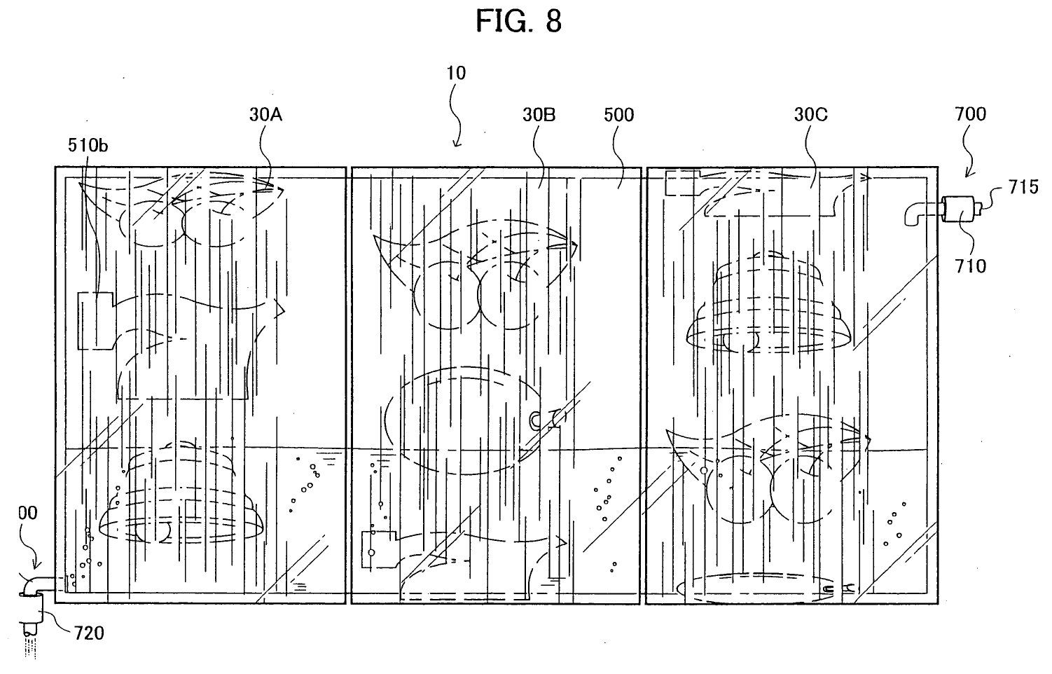

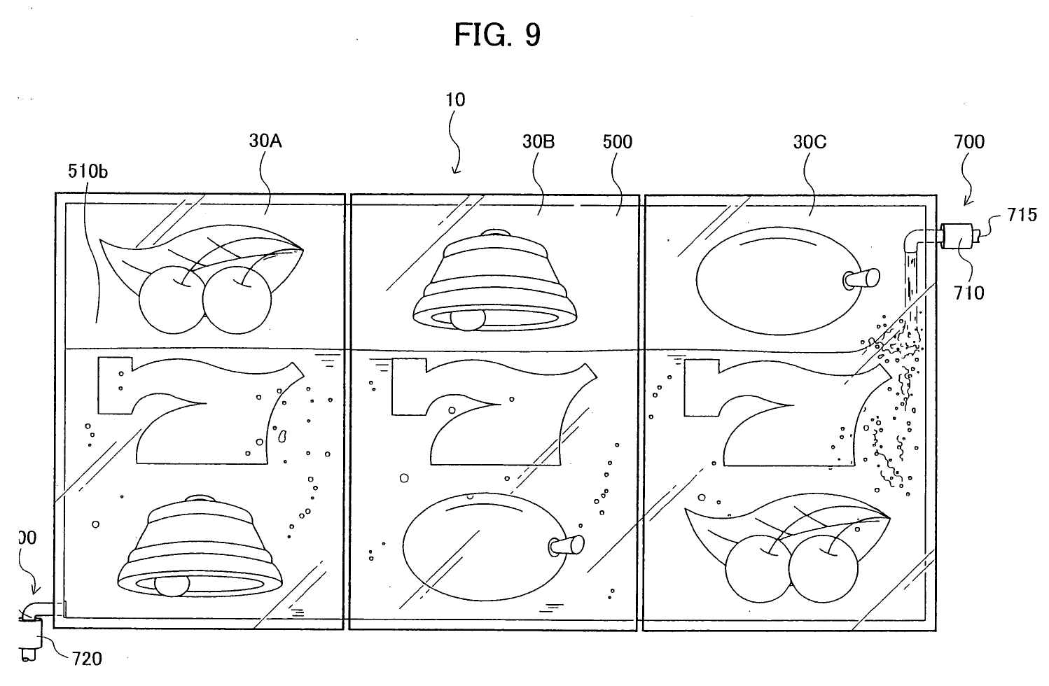

FIG. 8 and FIG. 9 are front views showing: the display screen 10 for displaying the mechanical reels 30A through 30C; the water tank 500; and a water amount changing means 700.

A slot machine according to the second embodiment differs from the first embodiment in that it includes the water amount changing means 700 instead of the wave generating means 600 included in the first embodiment.

Furthermore, the slot machine according to the second embodiment differs from the first embodiment in that it also includes a drive control circuit 400 instead of the drive control circuit 300 included in the first embodiment.

A description is provided regarding the structure of the water amount changing means 700, which serves as a liquid state changing means that changes the state of the liquid stored in the water tank 500.

FIG. 8 and FIG. 9 are front views showing: the display screen 10 for displaying the mechanical reels 30A through 30C; the water tank 500; and the water amount changing means 700.

The water amount changing means 700 includes: a liquid supply path 715 which allows liquid to be injected into the water tank 500; an injection valve 710 provided at an intermediate position on the liquid supply path 715, via which the amount of liquid to be injected into the water tank 500 is adjusted; a liquid drain path 725 which allows the liquid to be drained from the water tank 500; and a drain valve 720 which is provided at an intermediate position on the liquid drain path 725, via which the amount of liquid to be drained from the water tank 500 is adjusted.

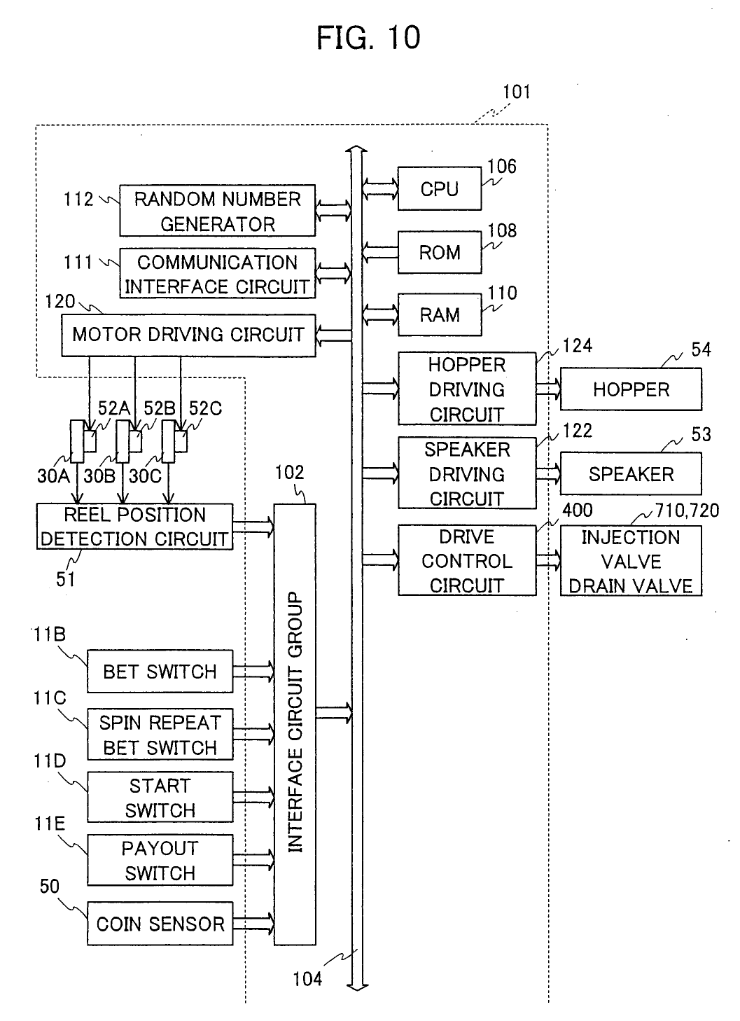

The liquid supply path 715 is connected to the upper portion of the water tank 500 via the injection valve 710. On the other hand, the liquid drain path 725 is connected to the lower portion of the water tank 500 via the drain valve 720. The injection valve 710 and the drain valve 720 are each driven and controlled by the drive control circuit 400 (see FIG. 10).

Next, a description is provided regarding the operation of the water amount changing means 700.

If the multiple kinds of indicating information provided on the mechanical reels 30A through 30C are displayed on the display screen 10 as shown in FIG. 8, the drain valve 720 of the water amount changing means 700 is driven and controlled by the drive control circuit 400 (see FIG. 10) so as to be opened, thereby draining the liquid stored in the water tank 500 from the water tank 500 via the liquid drain path 725. On the other hand, the injection valve 710 of the water amount changing means 700 is driven and controlled by the drive control circuit 400 (see FIG. 10) so as to be closed. Subsequently, if the indicating information provided on the mechanical reels 30A through 30C is displayed on the display screen 10 in a predetermined special stationary state (e.g., the indicating information “red 7”, “red 7”, and “red 7” are rearranged in the stationary state), the injection valve 710 of the water amount changing means 700 is driven and controlled by the drive control circuit 400 (see FIG. 10) so as to be opened, thereby injecting liquid into the water tank 500 through the liquid supply path 715. On the other hand, the drain valve 720 of the water amount changing means 700 is driven and controlled by the drive control circuit 400 (see FIG. 10) so as to be closed.

In other words, the water amount changing means 700 serves as an example of a water amount changing means which provides a function of injecting liquid into a water tank, and a function of draining the liquid from the water tank.

FIG. 10 is a block diagram showing an electrical configuration of a control device 101 according to the second embodiment of the present invention.

The drive control circuit 400 is also connected to the input/output bus 104, which provides a function of driving the injection valve 710 and the drain valve 720 of the water amount changing means 700. With such an arrangement, when a predetermined event occurs, the CPU 106 controls the operations of the injection valve 710 and the drain valve 720 via the drive control circuit 400, which controls the amount of liquid to be injected into the water tank 500 and the amount of liquid to be drained from the water tank 500.

In other words, the drive control circuit 400 serves as an example of a drive control means which controls the amount of liquid to be injected into a water tank, and the amount of liquid to be drained from the water tank.

Next, a description is provided regarding the operation of the CPU 106, which executes a game provided by the slot machine according to the second embodiment, with reference to a flowchart shown in FIG. 6.

The processing denoted by step S1 through step S4 is the same as in the first embodiment.

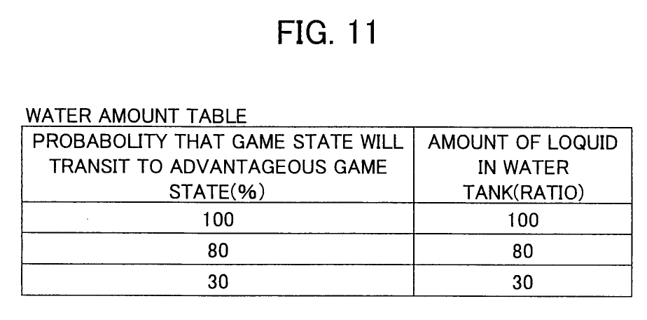

In step S5 and step S6, the CPU 106 performs water tank visual effect control processing. In this processing, the CPU 106 controls the operation of the injection valve 710 and the drain valve 720 via the drive control circuit 400 with reference to the water amount table (see FIG. 11) according to the determination result made in step S4. This controls the amount of liquid to be injected into the water tank 500 and the amount of liquid to be drained from the water tank 500. Upon completion of this processing, the CPU 106 switches the processing to step S7 or step S9.

The processing denoted by step S7 through step S9 is the same as in the first embodiment.

Next, a description is provided regarding the water amount table which is used by the CPU 106 as a reference in the aforementioned processing in step S5 and step S6.

FIG. 11 shows the water amount table.

The probability that the game state will transit to the advantageous game state and the corresponding amount of liquid to be stored in the water tank 500 are stored in the water amount table in the ROM 108. Specifically, if the probability that the game state will transit to the advantageous game state is 100%, the amount of liquid to be stored in the water tank 500 is set to 100; if the probability is 80%, the amount of liquid to be stored in the water tank 500 is set to 80; and if the probability is 30%, the amount of liquid to be stored in the water tank 500 is set to 30.

The second embodiment provides the following advantages.

(3) The drive control circuit 400 instructs the water amount changing means 700 to control the amount of liquid to be injected into the water tank 500 and the amount of liquid to be drained from the water tank.

Such an arrangement allows the amount of liquid to be injected into the water tank 500 and the amount of liquid to be drained from the water tank 500 to be changed, thereby allowing the level of the liquid in the water tank 500 to be changed. Thus, such an arrangement allows the level of the water stored in the water tank 500 to be changed according to the result of the determination of whether or not the game state is to be switched to a special game state advantageous to the player.

For example, with such an arrangement, the CPU 106 determines by random number lottery whether or not the game state is to be switched to a special game state advantageous to the player, upon which the drive control circuit 400 controls the amount of liquid to be injected into the water tank 500 and the amount of liquid to be drained from the water tank 500 using the water amount changing means 700 with reference to the water amount table, according to the result of the determination of whether or not the game state is to be switched to the special game state advantageous to the player. Here, the ROM 108 stores a water amount table that specifies the relation between the probability that the game state will transit to the advantageous game state, which is used in the random number lottery processing, and the amount of liquid to be stored in the water tank 500. In the water amount table, the amount of liquid to be stored in the water tank 500 is proportional to the probability that the game state will transit to the advantageous game state. With such an arrangement, the level of the liquid stored in the water tank 500 becomes higher as the probability that the game state will transit to the advantageous game state becomes higher. With such an arrangement, the rise in the level of the liquid stored in the water tank 500 further enhances the player's sense of expectation with respect to the game state transition to the special game state advantageous to the player.

Thus, such an arrangement provides improved visual effects by using the water tank 500, while facilitating the player's ability to visually recognize the information displayed on the mechanical reels 30A through 30C.

### Third Embodiment

In the following description of a third embodiment, the same components as those in the first embodiment are denoted by the same reference numerals, and description thereof is omitted or simplified.

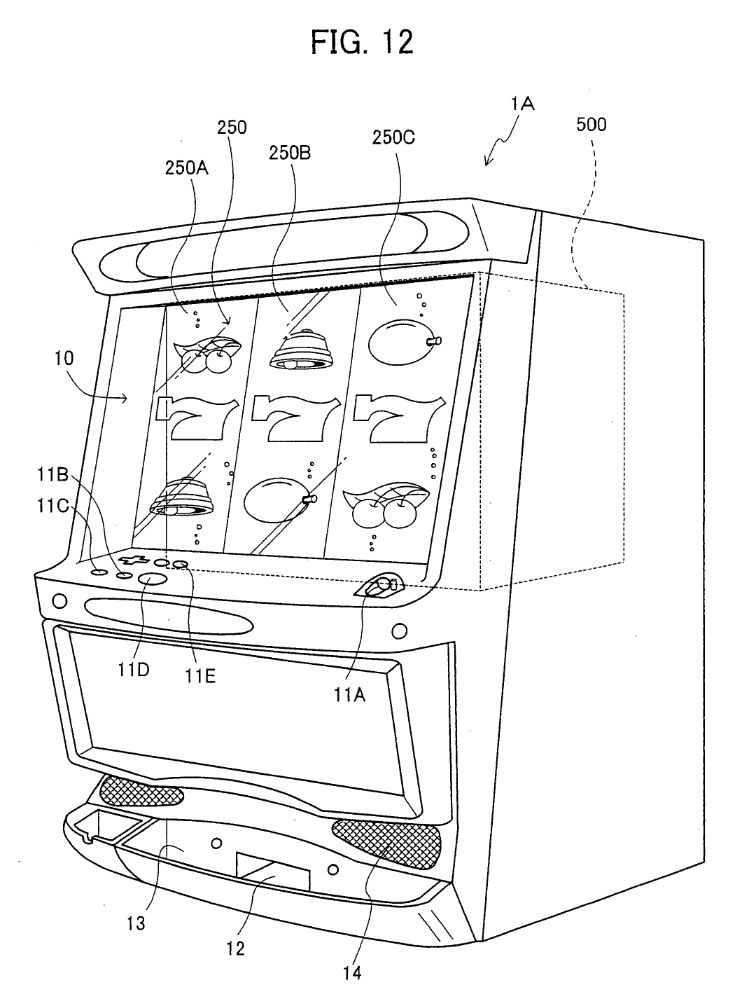

FIG. 12 is a perspective view showing the exterior of a slot machine 1A according to a third embodiment of the present invention.

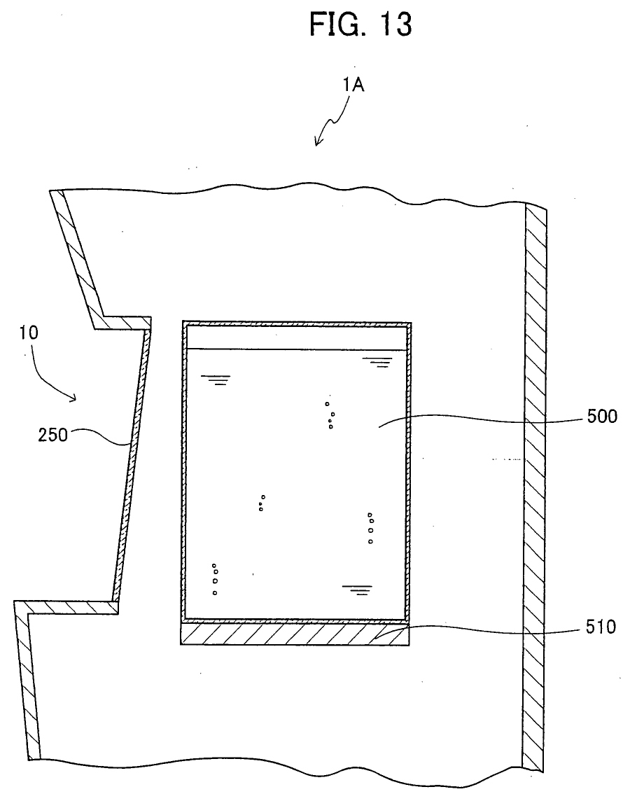

FIG. 13 is a cross-sectional view of a liquid crystal display device 250 and the water tank 500 included in the slot machine 1A according to the third embodiment of the present invention.

The slot machine 1A according to the third embodiment differs from the first embodiment in that it includes the liquid crystal display device 250 instead of the mechanical reels 30A through 30C included in the first embodiment.

Furthermore, the slot machine 1A according to the third embodiment differs from the first embodiment in that it also includes a display control device 200 instead of the motor driving circuit 120 included in the first embodiment.

The liquid crystal display device 250 is provided forward of the water tank 500, and has a function of displaying multiple kinds of indicating information on three indicating information display regions 250A through 250C variably and statically. Here, each of the three indicating information display regions 250A through 250C has a structure in which a transparent substrate such as a glass substrate, upon which a thin film transistor layer has been formed, and another transparent substrate are mounted so as to face each other with a certain gap between them, and the gap between the substrates is filled with a liquid crystal.

In other words, the liquid crystal display device 250 is provided forward of the water tank, and serves as an example of a liquid crystal display device which provides a function of displaying the indicating information variably and statically.

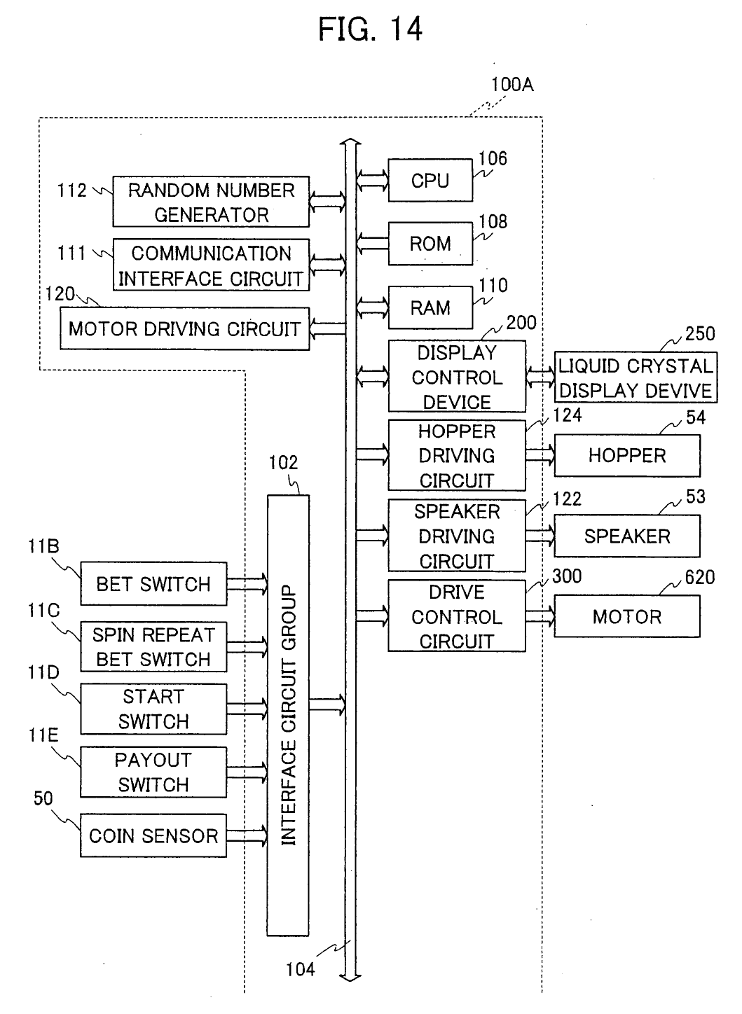

FIG. 14 is a block diagram showing an electrical configuration of a control device 100A according to the third embodiment of the present invention.

The display control device 200 is connected to the input/output bus 104. The CPU 106 generates an image display command corresponding to the state and results of the game, and outputs the image display command thus generated to the display control device 200 via the input/output bus 104. Upon reception of the image display command as an input signal from the CPU 106, the display control device 200 generates a driving signal for driving the liquid crystal display device 250 according to the image display command thus received. Then, the display control device 200 outputs the driving signal thus generated to the liquid crystal display device 250. With such an arrangement, the liquid crystal display device 250 provides a function of displaying multiple kinds of indicating information on the indicating information display regions 250A through 250C variably and statically.

In other words, the display control device 200 serves as an example of a display control means which is a display control circuit that controls the liquid crystal display device.

Next, a description is provided regarding the processing performed by the CPU 106, which executes a game provided by the slot machine 1 according to the third embodiment, with reference to the flowchart shown in FIG. 6.

The processing denoted by step S1 and the processing denoted by step S2 are the same as in the first embodiment.

In step S3, the CPU 106 performs indicating information variable display control processing. In this processing, the CPU 106 transmits a command to the display control device 200, which instructs the liquid crystal display device 250 to display multiple kinds of indicating information variably. Upon reception of this command, the display control device 200 performs a control operation so as to display multiple kinds of indicating information on the indicating information display regions 250A through 250C of the liquid crystal display device 250 variably. Upon completion of this processing, the CPU 106 switches the processing to step S4.

The processing denoted by step S4 through step S6 is the same as in the first embodiment.

In step S7, the CPU 106 performs a control operation so as to display the indicating information in a predetermined special stationary state. In this processing, the CPU 106 transmits a command to the display control device 200, which instructs the liquid crystal display device 250 to display the multiple kinds of indicating information in a predetermined special stationary state (e.g., the indicating information “red 7”, “red 7”, and “red 7” are rearranged in the stationary state). Upon reception of this command, after the multiple kinds of indicating information have been displayed on the indicating information display regions 250A through 250C of the liquid crystal display device 250 variably, the display control device 200 performs a control operation so as to display the indicating information in the predetermined special stationary state (e.g., the indicating information “red 7”, “red 7”, and “red 7” are rearranged in the stationary state). Upon completion of this processing, the CPU 106 switches the processing to step S8.

The processing denoted by step S8 is the same as that in the first embodiment.

In step S9, the CPU 106 performs a control operation so as to display the indicating information in a stationary state other than the aforementioned predetermined special state. In this processing, the CPU 106 transmits a command to the display control device 200, which instructs the liquid crystal display device 250 to display the indicating information in a stationary state other than the a special stationary state (e.g., the indicating information “red 7”, “red 7”, and “red 7” are rearranged in the stationary state) after the multiple kinds of indicating information have been displayed variably. Upon reception of this command, after the multiple kinds of indicating information have been displayed variably, the display control device 200 performs a control operation so as to display the indicating information on the indicating information display regions 250A through 250C of the liquid crystal display device 250 in a stationary state other than the special stationary state. Upon completion of this processing, the CPU 106 ends one game.

The third embodiment provides the following advantages. The liquid crystal display device 250, which is provided forward of the water tank 500, is employed as a display means. Furthermore, the display control device 200, which controls the liquid crystal display device 250, is employed as a display control means.

Such an arrangement allows the indicating information to be displayed variably and statically using various images. Furthermore, with such an arrangement, the liquid crystal display device 250 is formed of a translucent material, and is provided forward of the water tank 500. Such an arrangement allows the indicating information and the water tank to be displayed in a superimposed manner.

Thus, such an arrangement provides improved visual effects by using the water tank, while facilitating the player's ability to visually recognize the information displayed by the display means.

The embodiments according to the present invention have been described above with reference to specific examples for exemplary purposes only, and it should be clearly understood that the embodiments in no way restrict the present invention. That is to say, the gaming machine according to the present invention principally includes: an operating means which allows the player to operate the gaming machine; a game control means which provides a function whereby, upon the player performing an operation on the aforementioned operating means, determination is made whether or not the game state is to be switched to a special game state advantageous to the player; a display means which is formed of a translucent material, and which provides a function of displaying multiple kinds of indicating information variably and statically; a display control means which controls the display operation of the aforementioned display means, which has a function of displaying the indicating information variably and statically, according to the result of the determination made by the aforementioned game control means; a water tank which is formed of a translucent material, retains liquid, and is provided behind the display screen of the aforementioned display means for displaying the indicating information; a liquid state changing means which changes the state of the liquid stored in the water tank; and a drive control means which controls the aforementioned liquid state changing means according to the result of the determination made by the aforementioned game control means. With such an arrangement, the components such as the operating means, the game control means, the display means, the display control means, the water tank, the liquid state changing means, the drive control means, etc., may be modified and altered as suitable.

Moreover, it should be noted that the advantages described in association with the embodiments of the present invention are merely a listing of most preferred advantages of the present invention, and that the advantages of the present invention are by no means restricted to those described in connection with the embodiments of the present invention.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

### EXPLANATION OF THE REFERENCE SYMBOLS

1, 1A: slot machine
10: display screen
11: operation panel
12: coin payout opening
13: coin tray
14: sound output unit
30: reel group
30A to 30E: mechanical reel
100: control device
102: interface circuit group
104: input/output bus
106: CPU
108: ROM
110: RAM
111: communication interface circuit
112: random number generator
120: motor driving circuit
122: speaker driving circuit
124: hopper driving circuit
128: display unit driving circuit
200: display control device
250: liquid crystal display device
300, 400: drive control circuit
500: water tank
600: wave generating means
700: water amount changing means

What is claimed is:

1. A gaming machine comprising:
an operating device for allowing a player to operate the gaming machine;
a game control device for providing a function whereby, upon the player performing an operation on the operating device, determination is made whether or not a game state is to be switched to a special game state advantageous to the player;
a display device, which is formed of a translucent material, for displaying multiple kinds of indicating information variably and statically;
a display control device for controlling a display operation of the display device, which provides a function of displaying the indicating information variably and statically, according to a determination made by the game control device;
a water tank which is formed of a translucent material, retains liquid, and is provided behind a display screen of the display device for displaying the indicating information;
a liquid state changing device for changing the state of the liquid stored in the water tank; and
a drive control device for controlling the liquid state changing device according to the result of the determination made by the game control device.

2. A gaming machine according to claim 1, wherein the liquid state changing device is a wave generating device disposed in the liquid stored in the water tank, and having a movable plate member,
and wherein the drive control device controls the movement of the plate member of the wave generating device.

3. A gaming machine according to claim 1, wherein the liquid state changing device is a water amount changing device which provides a function of injecting liquid into the water tank, and a function of draining liquid from the water tank,
and wherein the drive control device controls via the water amount changing device the amount of the liquid to be injected into the water tank, and the amount of the liquid to be drained from the water tank.
